(19) United States
(12) Patent Application Publication
(10) Pub. No.: US 2021/0172241 A1
(43) Pub. Date: Jun. 10, 2021

(54) Systems and Methods for Magnetic Sliding Rails for Windows

(71) Applicant: Ram SHELI, Rishon Lezion (IL)

(72) Inventor: Ram SHELI, Rishon Lezion (IL)

(21) Appl. No.: 16/770,262

(22) PCT Filed: Nov. 21, 2018
(86) PCT No.: PCT/IB2018/059172

§ 371 Date: Jun. 5, 2020

Related U.S. Application Data
(60) Provisional application No. 62/594,555, filed on Dec. 5, 2017.
(60) Provisional application No. 62/641,423, filed on Mar. 12, 2018.

(51) Int. Cl. E06B 3/46

(52) U.S. Cl. CPC E06B 3/4618; E05Y 2900/148; E05Y 2201/684; E05Y 2201/462

(57) ABSTRACT

Systems and methods for a window system, comprising: a frame having a top channel and a bottom channel, wherein said bottom channel having at least one magnet wherein said magnet's north or south pole facing toward the open side of said channel; and a sliding window adapted to fit in said frame wherein the bottom part of said sliding window having a rail comprising at least one magnet wherein said magnet's is positioned revered from said channel's magnet in order to create a magnetic repelling effect; wherein said magnets and said magnetic repelling effect allow the window to move within said channel.

### BACKGROUND

### 1. Technical Field

Embodiments of the present invention relate generally to systems and methods for magnetic sliding rails for windows.

### 2. Description of Related Art

Now days windows systems are having many flaws such as wheels faults that requires technical maintenance, dirt cluttering the bottom channel, narrow or unreachable channels that prevent cleaning, etc.

Hence, an improved systems and methods as described in this application are still a long felt need.

### BRIEF SUMMARY

According to an aspect of the present invention a window system, comprising: a frame having a top channel and a bottom channel, wherein said bottom channel having at least one magnet wherein said magnet's north or south pole facing toward the open side of said channel; and a sliding window adapted to fit in said frame wherein the bottom part of said sliding window having a rail comprising at least one magnet wherein said magnet's is positioned revered from said channel's magnet in order to create a magnetic repelling effect; wherein said magnets and said magnetic repelling effect allow the window to move within said channel.

It is further within provision of the invention to be wherein said magnet is an electromagnet.

It is further within provision of the invention to further comprise: a magnetic field generator located in said frame or in said sliding window; at least one sensor adapted to sense a user intending to use said window system and stopping using said window system, located in said frame or in said sliding window; a controller to activate and deactivate said magnetic field generator.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates the components of an embodiment of the present invention; and

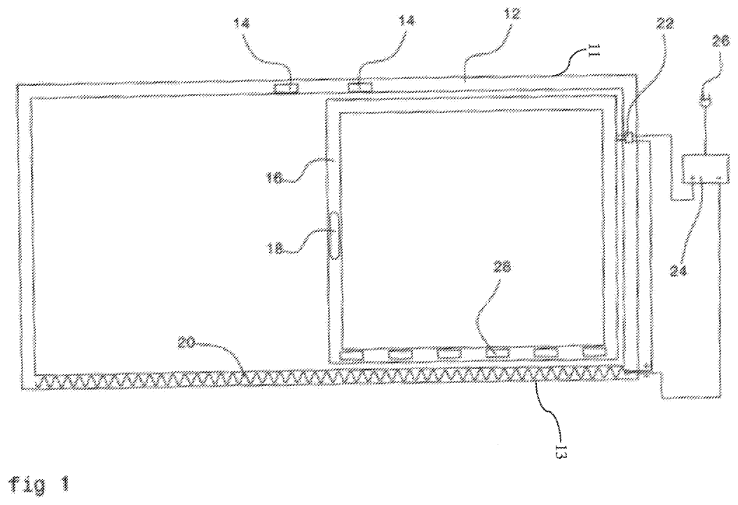

FIG. 2 illustrates the components of an embodiment of the present invention.

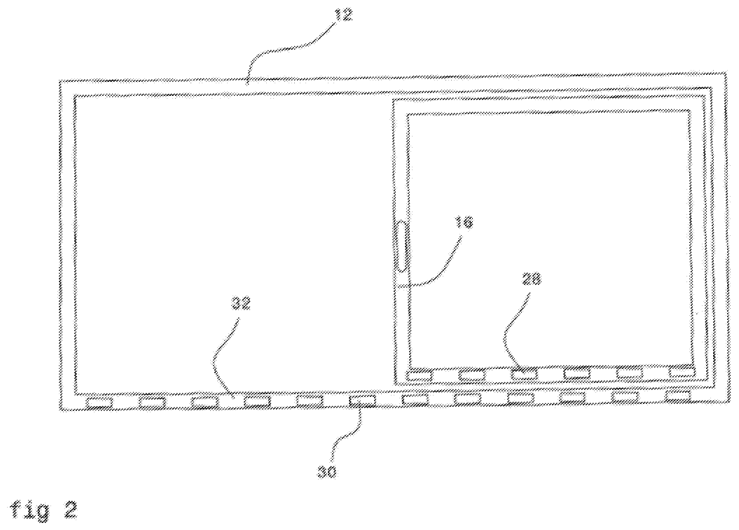

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for magnetic sliding rails for windows.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A. B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for allowing an accessible, aesthetically pleasing, smoothly moved window as well as an easier to use, clean and maintain window system.

Generally speaking, the system and method may allow making use of the repelling effects of magnet when placing the same pole of plurality of magnets facing each other in order to support a window within a window frame.

An embodiment of the present invention may be wherein the window system comprising a frame 11 having a top channel 12 and a bottom channel 13, wherein the bottom channel having one or more magnets 30 wherein the magnets' north or south pole facing toward the open side (all facing the same direction, in case of multiple separated magnets) of said channel (i.e. toward the sliding window 16).

A sliding window 16 adapted to fit in the frame wherein the bottom part of said sliding window having a rail comprising at least one magnet 28 wherein said magnet's is positioned revered from said channel's magnet in order to create a magnetic repelling effect (once again, all facing the same direction, in case of multiple separated magnets).

Placing the magnets in that manner will create a repelling effect and hence may allow the window to move within the channel upon user's choice.

In some embodiments of the invention, the magnet may be an electromagnet.

The electromagnet may be any electromagnet as known in the art and such may be activated and deactivated by the user in a manual mode.

In a further embodiment of the invention, the control may be automatic or semi-automatic. For example, the system may include a magnetic field generator located in the frame or in the sliding window.

One or more sensors 14 may be placed in the system's components wherein the sensors may be adapted to sense a user intending to use the window system and stopping using the window system.

Such sensor may be any relevant sensor known in the art including infrared sensor, proximity sensor, heat sensor, camera, microphone, etc.

A controller to activate and deactivate the magnetic field generator may further be installed as part of the system.

In a specific embodiment of the invention, the system may have an infrared sensor located in the handle 18 of the sliding window. When the sensor sense the user's hand it may activate the electromagnet field generator 20 which is connected to a power source 26, which are connected to a controller 24 and a switch 22.

The use may be, as in some embodiments, time limited due to predefined parameter by the user or as result of electric charging limitations set by a manufacturer of such system.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A window system, comprising:
a frame having a top channel and a bottom channel, wherein said bottom channel having at least one magnet wherein said magnet's north or south pole facing toward the open side of said channel; and
a sliding window adapted to fit in said frame wherein the bottom part of said sliding window having a rail comprising at least one magnet wherein said magnet's is positioned revered from said channel's magnet in order to create a magnetic repelling effect;
wherein said magnets and said magnetic repelling effect allow the window to move within said channel.

2. The system of claim 1 wherein said magnet is an electromagnet.

3. The system of claim 2, further comprising:
a magnetic field generator located in said frame or in said sliding window;
at least one sensor adapted to sense a user intending to use said window system and stopping using said window system, located in said frame or in said sliding window;
a controller to activate and deactivate said magnetic field generator.
